(19) United States
(12) Patent Application Publication
(10) Pub. No.: US 2023/0419676 A1
(43) Pub. Date: Dec. 28, 2023

(54) RELIABILITY CORRECTION DEVICE, RELIABILITY CORRECTION METHOD, AND VEHICLE OPERATING SYSTEM

(71) Applicant: Mitsubishi Electric Corporation, Tokyo (JP)

(72) Inventors: Naoyuki TSUSHIMA, Tokyo (JP); Koji IIDA, Tokyo (JP); Tomohiro AKIYAMA, Tokyo (JP)

(73) Assignee: Mitsubishi Electric Corporation, Tokyo (JP)

(21) Appl. No.: 18/035,856

(22) PCT Filed: Dec. 25, 2020
(86) PCT No.: PCT/JP2020/048854

§ 371 Date: May 8, 2023

(51) Int. Cl. G06V 20/56; G06V 10/141; G06V 10/60; G06V 10/98

(52) U.S. Cl. CPC G06V 20/56; G06V 10/141; G06V 10/60; G06V 10/993; B60W 60/00

(57) ABSTRACT

A reliability correction device is provided in which a target-matter is detected by means of a camera and/or a radar, and a reliability modification unit included in the device modifies the degree of reliability with respect to target-matter information being detected, on the basis of an irradiation range(s) being an irradiation region(s) of a light(s).

### TECHNICAL FIELD

The disclosure of the present application relates to a reliability correction device for modifying the degree of reliability with respect to a result of a target-matter detected by a sensor(s), a method of modifying the degree of reliability therewith, and a motor vehicle driving or operating system.

### BACKGROUND ART

Conventionally, it has been so arranged that, at a time when a target-matter which exists in the surroundings of a sensor(s) is detected by using a plurality of sensors such as a camera, a millimeter-wave radar and/or the like, the weighting on the degree of reliability of a target-matter having been detected by the plurality of sensors is increased, so that the target-matter is selected as an existing target-matter. As a device in which target-matter detection results by means of a plurality of sensors are combined or fused each other, a device stated in Patent Document 1 is known, for example.

### RELATED ART DOCUMENT

### Patent Document

[Patent Document 1] Japanese Patent Publication No. 4941265

### SUMMARY OF THE INVENTION

### Problems to be Solved by the Invention

According to a conventional technology stated in Patent Document 1, for example, it is difficult to detect a target-matter by means of a camera in a situation where it is dark in the surroundings of the camera, because a target-matter which exists in a range where a light(s) does not illuminate it is thus dark owing to lack of the illuminance. If the target-matter is not detected by the camera, and if the target-matter is detected only by a millimeter-wave radar, the degree of reliability given to the detected target-matter is decreased, which exerts difficulty in selecting the target-matter as an existing target-matter. In a case in which an output having been detected is used for automated driving by an automotive vehicle, it is feared that the detection of a target-matter may be delayed, or the target-matter may be left undetectable.

In addition, in the conventional technology, the degree of reliability is weighted on information detected by a camera, and, further when the detection result by the camera is coincident with a detection result by the radar, the existence of an obstacle is determined by presuming that the degree of reliability exceeds a predetermine value.

However, in the conventional technology, a change(s) of detection ability based on an environmental condition of each sensor is not taken into consideration. For example, when there exists a pedestrian or the like at a place where lights are not served and detection is difficult by means of a camera during the night, and when the detection is only performed by a radar, the existence of the pedestrian results in being escaped in the conventional technology.

The present disclosure in the application concerned has been directed at solving those problems as described above, an object of the disclosure is to obtain a reliability modification or correction device by which detection reliability of a target-matter by means of a sensor(s) is made incorporating the characteristics of the sensor(s), so that more accurate detection can be achieved.

### Means for Solving the Problems

In a reliability modification or correction device disclosed in the disclosure of the application concerned for modifying the degree of reliability with respect to a detection result(s) of a target-matter, by a sensor(s), existing in the surroundings of the sensor(s), the reliability correction device comprises a reliability modification unit for modifying the degree of reliability with respect to target-matter information being detected, on the basis of an irradiation range(s) being an irradiation region(s) of lights.

### Effects of the Invention

According to the reliability correction device disclosed in the disclosure of the application concerned, detection reliability of a target-matter by means of a sensor(s) is made incorporating the characteristics of the sensor(s), so that more accurate detection can be achieved.

### BRIEF DESCRIPTION OF DRAWINGS

FIG. 1 is a block diagram illustrating a configuration of a reliability correction device according to Embodiment 1;

FIG. 2 is a block diagram for explaining the functions in the reliability correction device according to Embodiment 1;

FIG. 3 is a diagram for explaining the degree of reliability of target-matter detection in the reliability correction device according to Embodiment 1;

FIG. 4 is a flowchart showing processing procedures of reliability modification in the reliability correction device according to Embodiment 1;

FIG. 5 is a block diagram illustrating a configuration of a reliability correction device according to Embodiment 2;

FIG. 6 is a block diagram for explaining the functions in the reliability correction device according to Embodiment 2;

FIG. 7 is a diagram for explaining the degree of reliability of target-matter detection in the reliability correction device according to Embodiment 2;

FIG. 8 is a flowchart showing processing procedures of reliability modification in the reliability correction device according to Embodiment 2;

FIG. 9 is a block diagram for explaining the functions in a reliability correction device according to Embodiment 3; and

FIG. 10 is a flowchart showing processing procedures of illumination range calculation in the reliability correction device according to Embodiment 3.

### EMBODIMENTS FOR CARRYING OUT THE INVENTION

### Embodiment 1

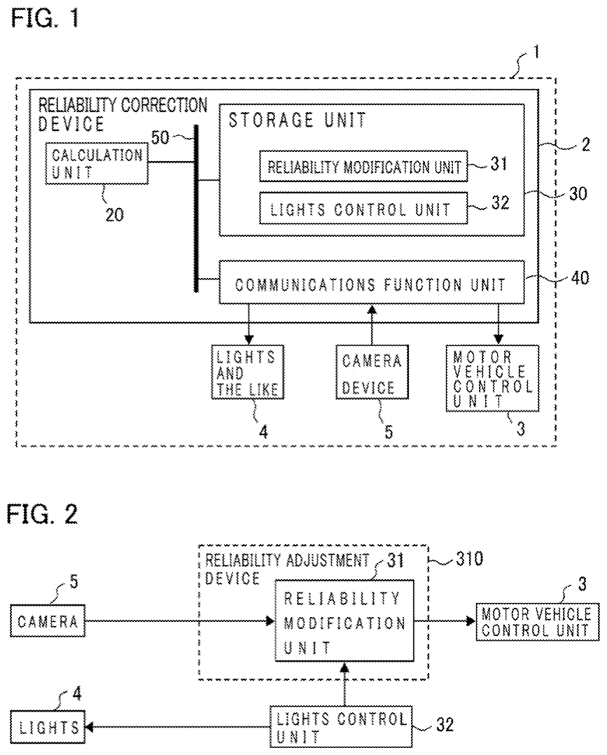

FIG. 1 is a block diagram illustrating a schematic configuration of a reliability modification or correction device according to Embodiment 1.

With an automotive or motor vehicle 1, provided as its onboard devices are the reliability correction device 2, a motor vehicle control unit 3, lights-and-the-like (hereinafter, also referred to as “lights”) 4, and a camera device (hereinafter, also referred to as a “camera”) 5.

The reliability correction device 2 comprises a calculation unit 20, a storage unit 30, a communications function unit 40, and a bus 50. The calculation unit 20, the storage unit 30 and the communications function unit 40 are connected so that they are capable of bidirectionally communicating with one another by way of the bus 50. In addition, the communications function unit 40 performs transmission/reception of a control signal(s) and transmission/reception of an information signal(s) with respect to the motor vehicle control unit 3, the lights-and-the-like 4, the camera device 5, and the like. The lights 4 and the camera 5 are both mounted on the motor vehicle being a vehicular or mobile object.

The calculation unit 20 is constituted of a calculation device(s) such as a microprocessor or microcomputer, a DPS, and/or the like. The storage unit 30 is constituted of a RAM and a ROM, and the storage unit includes a reliability modification unit 31 and a lights control unit 32. The camera 5 is a general optical camera of visible light rays which focuses an appearance of targeted sensing area onto an image pickup device by means of lenses or the like; however, if lights being irradiated are of infrared light rays, an infrared camera may also be appropriate.

FIG. 2 is a block diagram for explaining the functions in the reliability correction device according to Embodiment 1.

Into the reliability modification unit 31 constituting the reliability adjustment device 310, a target-matter detection result(s) by means of the camera 5 is inputted, and information of an irradiation range(s) is inputted from the lights control unit 32. The lights control unit 32 outputs a control signal(s) of a lights irradiation region(s) with respect to the lights 4. From the reliability modification unit 31, a target-matter detection result(s) is outputted with respect to the motor vehicle control unit 3. As for the motor vehicle 1, its operations are controlled by means of the motor vehicle control unit 3 in accordance with the output(s) from the reliability modification unit 31, whereby a motor vehicle driving or operating system is configured.

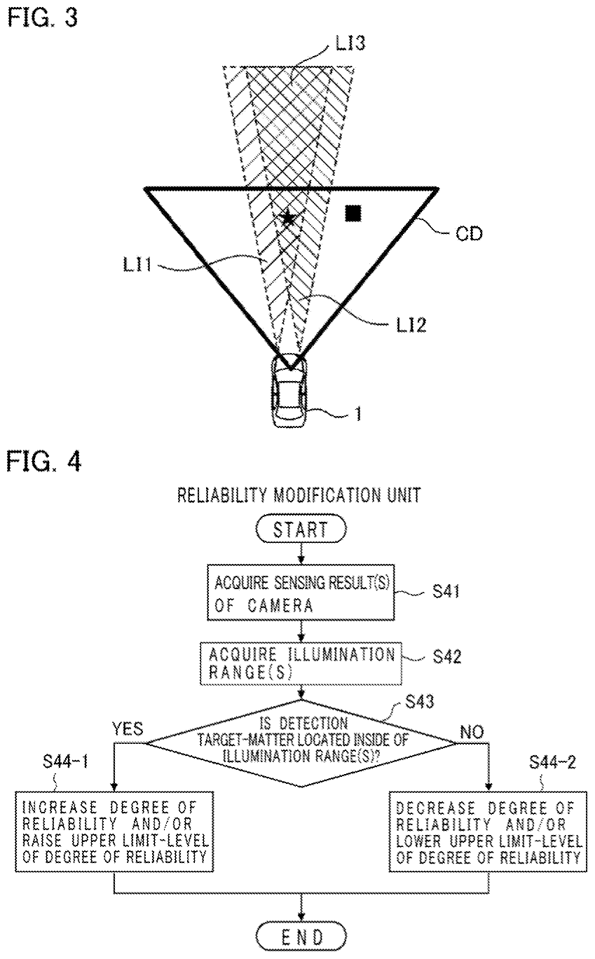

FIG. 3 is a diagram for explaining the degree of reliability of target-matter detection in the reliability correction device according to Embodiment 1. In FIG. 3, a range LI1 surrounded by the broken lines is an irradiation region formed by means of a left-hand side's headlight being a light provided with the motor vehicle 1, and a range LI2 surrounded by the broken lines is an irradiation region formed by means of a right-hand side's headlight being a light provided with the motor vehicle; and the portion where the range LI1 and the range LI2 overlap with each other is indicated by a range LI3. In addition, a detection region CD formed by means of a camera mounted toward the front of the motor vehicle 1 is indicated by the triangular shape of solid line. In FIG. 3, the solid star mark indicates a case in which a location of a detection target-matter is inside of an irradiation region of the lights 4, and also the case in which the detection target-matter is inside of a coverage area of the camera 5 (state A); and the solid rectangular mark indicates a case in which a location of a detection target-matter is outside of the irradiation regions of the lights 4, and also the case in which the detection target-matter is inside of the coverage area of the camera 5 (state B).

In FIG. 3, the explanation will be made for reliability modification or correction when target-matter detection is carried out in the camera 5.

In FIG. 3, when target-matter detection is carried out by means of the camera 5, the degree of reliability is increased in the state A in the reliability modification unit 31, and/or an upper limit-level of the degree of reliability is raised in the state A in the reliability modification unit, so that the degree of reliability is adjusted. The motor vehicle control unit 3 carries out the controls of the motor vehicle in accordance with a reliability correction or modification output(s) from the reliability modification unit 31. Namely, accurate detection is expected for the target-matter detection in the irradiation ranges of the lights 4.

In FIG. 3, because the lights 4 are not irradiated in the state B, and because it is feared that the detection capability of the camera 5 is degraded, the degree of reliability is decreased, and/or an upper limit-level of the degree of reliability is lowered, so that the degree of reliability is adjusted.

As for the degree of reliability, when it is outputted based on a detection result of a target-matter by means of the camera 5, a level or the degree of pattern matching is incorporated in such a scheme of distinguishing a pattern through the pattern matching, for example.

In addition, it is so arranged that an illumination range(s) is obtained from the lights control unit 32. Namely, a signal(s) indicating an irradiation range(s) from the lights control unit 32 is inputted into the reliability modification unit 31. When the control is enabled to turn on a light(s) or turn off the light(s) in a detailed range(s) in such a case of an adaptive headlight(s), a turn-on situation of the light(s) or a turn-off situation thereof is transmitted in each of the ranges in a format in which the shape of a sector or fan is divided into those ranges in mesh shapes, for example. When the control is simply enabled to turn on or turn off the lights, the irradiation region(s) (which differs depending on high beam, low beam, or the like) is transmitted in a case of the turn-on.

Note that, when the lights in this case are lights which are mounted on the motor vehicle, namely, on the host vehicle itself, the irradiation region(s) can be easily acquired. However, because there exists the lighting such as streetlights or the like in the road environments, a high degree of effectiveness can be achieved by taking these into consideration.

FIG. 4 is a flowchart showing processing procedures of reliability modification in the reliability correction device according to Embodiment 1.

First, a sensing result(s) of the camera 5 is acquired (Step S41); on the basis of the sensing result(s), an irradiation range(s) of a light(s) is acquired (Step S42); and next, determination is performed whether or not a detection target-matter is located inside of an illumination range(s) of the light(s) (Step S43).

On the determination at Step S43, when the detection target-matter is located inside of the illumination range(s) of the light(s), the processing proceeds to Step S44-1, so that the degree of reliability is increased and/or an upper limit-level of the degree of reliability is raised.

On the determination at Step S43, when the detection target-matter is not located inside of the illumination range(s) of the light(s), the processing proceeds to Step S44-2, so that the degree of reliability is decreased and/or a lower limit-level of the degree of reliability is lowered.

### Embodiment 2

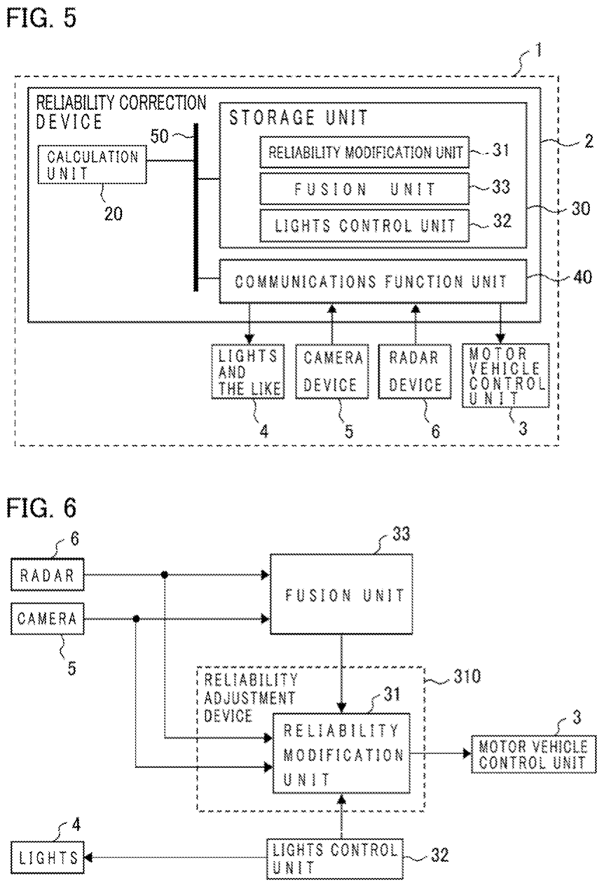

FIG. 5 is a block diagram illustrating a configuration of a reliability modification or correction device according to Embodiment 2.

In Embodiment 2, included in addition to the configuration of Embodiment 1 are a radar device (hereinafter, also referred to as a “radar”) 6, and a fusion unit 33. Other constituent items and components in the configuration are equivalent or similar to those in Embodiment 1. The storage unit 30 includes the fusion unit 33; and in addition, the radar 6 includes a target-matter reflection-level reception unit and a target-matter detection unit.

The radar device 6 is a sensor which ejects radio waves, so that, by receiving reflection waves reflected by a targeted object-matter, a location of the targeted object-matter and the distance thereof are detected. Also other than the radar, another sensor may be appropriate if the sensor is configured so that it can detect a targeted object-matter, and it can detect a reflection-level(s) of a target-matter; and so, a LIDAR, an ultrasonic sensor and/or the like may also be appropriate.

FIG. 6 is a block diagram for explaining the functions in the reliability correction device according to Embodiment 2.

Into the reliability modification unit 31 constituting the reliability adjustment device 310, inputted is a target-matter fusion result(s) obtained by the fusion unit 33 on the basis of a target-matter detection result(s) inputted from the camera 5 and that inputted from the radar 6. In addition, into the reliability modification unit 31, inputted are a target-matter detection result(s) from the camera 5 and that from the radar 6, and also, information of a irradiation range(s) from the lights control unit 32. The lights control unit 32 outputs a control signal(s) of a lights irradiation region(s) with respect to the lights 4. From the reliability modification unit 31, a target-matter fusion result(s) is outputted with respect to the motor vehicle control unit 3.

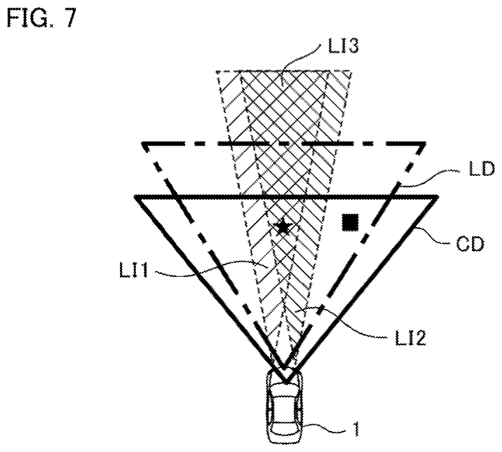

FIG. 7 is a diagram for explaining the degree of reliability of target-matter detection in the reliability correction device according to Embodiment 2. In FIG. 7, a range LI1 surrounded by the broken lines is an irradiation region formed by means of a left-hand side's headlight being a light provided with the motor vehicle 1, and a range LI2 surrounded by the broken lines is an irradiation region formed by means of a right-hand side's headlight being a light provided with the motor vehicle; and the portion where the range LI1 and the range LI2 overlap with each other is indicated by a range LI3. In addition, a detection region CD formed by means of a camera mounted toward the front of the motor vehicle 1 is indicated by the triangular shape of solid line; and a detection region LD formed by means of a radar mounted toward the front of the motor vehicle 1 is indicated by the triangular shape of alternate long and short dashed lines. In FIG. 7, the solid star mark indicates a case in which a location of a detection target-matter is inside of an irradiation region of the lights 4, and also the case in which the detection target-matter is inside of a coverage area of the camera 5 and that of the radar 6 (state C); and the solid rectangular mark indicates a case in which a location of a detection target-matter is outside of the irradiation regions of the lights 4, and also the case in which the detection target-matter is inside of the coverage area of the camera 5 and that of the radar 6 (state D).

In FIG. 7, the explanation will be made for the modification or adjustment of the degree of reliability in a case in which target-matter detection is carried out only in the radar 6. In the reliability modification unit 31, the degree of reliability is decreased in the state C, and/or an upper limit-level of the degree of reliability is lowered in the state C, so that the degree of reliability is adjusted. In addition, because the lights are not illuminated in the state D, and because detection cannot be carried out because of the degradation of the detection capability of the camera, it is defined that the degree of reliability is not changed, and/or that an upper limit-level of the degree of reliability is not changed. Namely, accurate detection is expected because of an irradiation range of the lights 4; however, detection is not yet carried out by the radar, and so, the degree of reliability is maintained.

In FIG. 7, the explanation will be made for the modification or adjustment of the degree of reliability in a case in which target-matter detection is carried out only in the camera 5. In the reliability modification unit 31, the degree of reliability is not changed in the state C, and/or an upper limit-level of the degree of reliability is not changed in the state C. Namely, accurate detection is expected because of an illumination range of the lights; however, the target-matter is not yet detected by the radar 6, and so, the degree of reliability is maintained. Moreover, because the lights 4 are not irradiated in the state D, and because it is feared that the detection ability of the camera is degraded, the degree of reliability is decreased, and/or an upper limit-level of the degree of reliability is lowered, so that the degree of reliability is adjusted.

Next, in FIG. 7, the explanation will be made for the modification or adjustment of the degree of reliability in a case in which target-matter detection is carried out by both of the camera 5 and the radar 6. In the reliability modification unit 31, the degree of reliability is increased in the state C, and/or an upper limit-level of the degree of reliability is raised in the state C, so that the degree of reliability is adjusted. Namely, accurate detection is expected because of the irradiation range of the lights 4. Furthermore, in the state D, it is defined that the degree of reliability is not changed, and/or that an upper limit-level of the degree of reliability is not changed. Namely, the lights 4 are not irradiated, and the detection capability of the camera 5 is degraded; however, the detection can also be carried out by the radar 6, and so, the degree of reliability is maintained.

As for the degree of reliability, when it is outputted from the camera 5, a level or the degree of pattern matching is incorporated in such a scheme of distinguishing a pattern(s) through the pattern matching, for example. In a case of a millimeter-wave sensor, for example, the magnitude of SNR of a detection target-matter is incorporated. In addition, when those go through the fusion, its result changes depending on cases such as: the same target-matter can be continuously detected in a time series; variations of a location of the target-matter being detected and/or those of a speed thereof are small; and so forth.

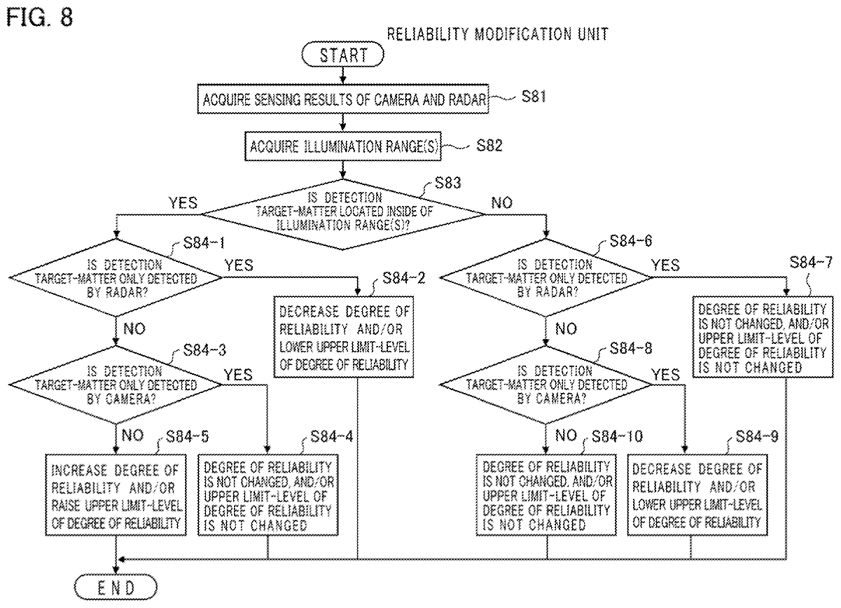

FIG. 8 is a flowchart showing processing procedures of reliability modification in the reliability correction device according to Embodiment 2.

First, a sensing result(s) of the camera 5 and that of the radar 6 are acquired (Step S81); on the basis of the sensing results, an irradiation range(s) of a light(s) is acquired (Step S82); and next, determination is performed whether or not a detection target-matter is located inside of an illumination range(s) of the light(s) (Step S83).

On the determination at Step S83, when the detection target-matter is located inside of the illumination range(s) of the light(s), determination is performed whether or not the detection target-matter is only detected by the radar 6 (Step S84-1); and, when the detection target-matter is only detected by the radar 6, the degree of reliability is decreased, and/or an upper limit-level of the degree of reliability is lowered, so that the degree of reliability is adjusted (Step S84-2).

At Step S84-1, when the detection target-matter is not only detected by the radar 6, determination is performed whether or not the detection target-matter is only detected by the camera 5 (Step S84-3); and, when the detection target-matter is only detected by the camera 5, the degree of reliability is not changed, and/or an upper limit-level of the degree of reliability is not changed, so that the degree of reliability is maintained (Step S84-4).

At Step S84-3, when the detection target-matter is not only detected by the camera 5, the degree of reliability is increased, and/or an upper limit-level of the degree of reliability is raised, so that the degree of reliability is adjusted.

On the determination at Step S83, when the detection target-matter is not located inside of the illumination range(s) of the light(s), determination is performed whether or not the detection target-matter is only detected by the radar 6 (Step S84-6); and, when the detection target-matter is only detected by the radar 6, the degree of reliability is not changed, and/or an upper limit-level of the degree of reliability is not changed, so that the degree of reliability is maintained (Step S84-7).

At Step S84-6, when the detection target-matter is not only detected by the radar 6, determination is performed whether or not the detection target-matter is only detected by the camera 5 (Step S84-8); and, when the detection target-matter is only detected by the camera 5, the degree of reliability is decreased, and/or an upper limit-level of the degree of reliability is lowered, so that the degree of reliability is adjusted (Step S84-9).

At Step S84-8, when the detection target-matter is not only detected by the camera 5, the degree of reliability is not changed, and/or an upper limit-level of the degree of reliability is not changed, so that the degree of reliability is maintained.

### Embodiment 3

In Embodiment 1 and Embodiment 2, the configuration is adopted in such a manner that an irradiation region(s) of the lights is obtained from the lights control unit 32. However, because there exists the lighting such as lights of another vehicle or other vehicles and/or streetlights or the like in the road environments other than the lights of a host vehicle itself, a high degree of effectiveness can be achieved by taking these into consideration.

For dealing therewith, in the embodiment, it is so arranged that, as for an image(s) obtained from the camera 5, an irradiation region(s) of the lighting such as the lights of the host vehicle and that of the lighting such as lights of another vehicle, streetlights or the like are obtained from a high-intensity (bright) range(s) and from a low-intensity (dark) range(s).

Note that, the irradiation region(s) being obtained is a irradiation region(s) from a camera's viewpoint of the host vehicle; and so, when the irradiation region(s) is practically used, viewpoint transformation (a general algorithm is adequate) or the like is performed so that the transformation achieves an aerial or bird's eye range(s).

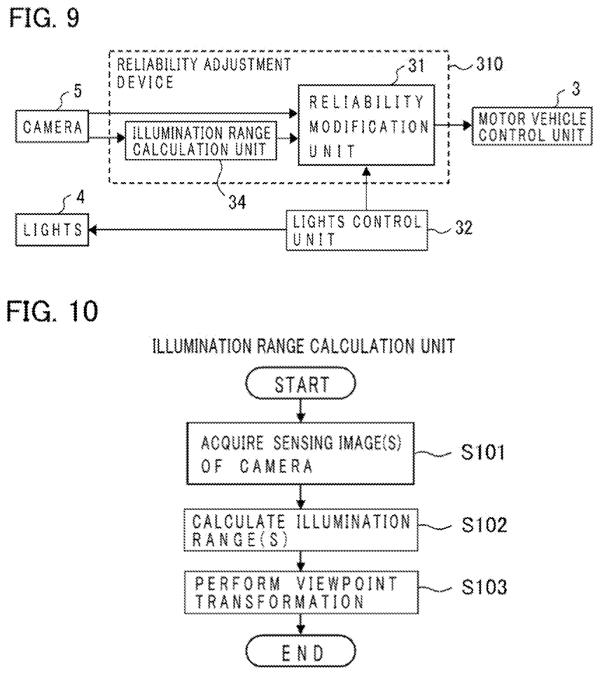

FIG. 9 is a block diagram for explaining the functions in a reliability modification or correction device according to Embodiment 3.

In Embodiment 3, the configuration is adopted so that an illumination range calculation unit 34 is added to Embodiment 1. On the basis of a frontward image(s) from the camera 5, it is so arranged that an illumination range(s) of lights is obtained in the illumination range calculation unit 34, so that information of the illumination range(s) is also inputted from the illumination range calculation unit 34 into the reliability modification unit 31, similarly to the information of an illumination range(s) from the lights control unit 32. Other constituent items and components in the configuration are the same as or equivalent to those in Embodiment 1.

FIG. 10 is a flowchart showing processing procedures of illumination range calculation of a reliability adjustment device in the reliability correction device according to Embodiment 3.

In the illumination range calculation unit 34, first, a sensing image(s) of the camera 5 is acquired (Step S101), and, next, an illumination range(s) of the lights 4 is calculated from the image(s) obtained at Step S101 (Step S102), so that, in accordance with the result, viewpoint transformation is performed (Step S103).

In each embodiment of Embodiment 1, Embodiment 2 or Embodiment 3, the description is made for the device as a device which is mounted on a motor vehicle; however, the device is not necessarily limited to mounting on the motor vehicle, so that the degree of reliability can also be similarly modified in accordance with information of a camera(s) and/or that of a radar(s) mounted on a roadside unit or an apparatus immediately beside a road(s). Moreover, in Embodiment 3, it is defined that the sensor includes only a camera; however, it can be also applicable to a configuration in which both of the camera and the radar are utilized as in Embodiment 2.

In the present disclosure of the application concerned, various exemplary embodiments and implementation examples are described; however, various features, aspects and functions described in one or a plurality of embodiments are not necessarily limited to the applications of a specific embodiment(s), but are applicable in an embodiment(s) solely or in various combinations. Therefore, limitless modification examples not being exemplified can be presumed without departing from the scope of the technologies disclosed in Description of the disclosure of the application concerned. For example, there arise cases which are included as a case in which at least one constituent element is modified, added or eliminated, and further a case in which at least one constituent element is extracted and then combined with a constituent element(s) of another embodiment.

### EXPLANATION OF NUMERALS AND SYMBOLS

Numeral “1” designates a motor vehicle; “2,” reliability correction device; “3,” motor vehicle control unit; “4,” lights (lights and the like); “5,” camera (camera device); “6,” radar (radar device); “31,” reliability modification unit; and “32,” lights control unit.

1. A reliability correction device for modifying a degree of reliability with respect to a detection result of a target-matter, by a sensor, existing in surroundings of said sensor, the reliability correction device, comprising:
a reliability modification device for modifying a degree of reliability with respect to target-matter information being detected, on a basis of an irradiation range being an irradiation region of a light.

2. The reliability correction device as set forth in claim 1, wherein the irradiation region includes an irradiation region of a light mounted on an apparatus with which said sensor is provided.

3. The reliability correction device as set forth in claim 1, further comprising: an illumination range calculation device for calculating the irradiation region from a range in accordance with intensity of an image obtained from said sensor.

4. The reliability correction device as set forth in claim 1, wherein the reliability correction device is mounted on a motor vehicle.

5. The reliability correction device as set forth in claim 1, wherein said sensor includes a camera.

6. The reliability correction device as set forth in claim 5, wherein the reliability modification device increases a value of the degree of reliability and/or raises an upper limit-level of the degree of reliability, when a location of the target-matter is inside of an irradiation region of the light.

7. The reliability correction device as set forth in claim 5, wherein the reliability modification device decreases a value of the degree of reliability and/or lowers an upper limit-level of the degree of reliability, when a location of the target-matter is outside of an irradiation region of the light.

8. The reliability correction device as set forth in claim 1, wherein said sensor includes a camera and a radar.

9. The reliability correction device as set forth in claim 8, wherein the reliability modification device decreases a value of the degree of reliability and/or lowers an upper limit-level of the degree of reliability, when the radar only detects a target-matter and the camera does not detect a target-matter, and when a location of the target-matter is inside of an irradiation region of the light.

10. The reliability correction device as set forth in claim 8, wherein the reliability modification device does not change a value of the degree of reliability and/or does not change an upper limit-level of the degree of reliability, when the camera only detects a target-matter and the radar does not detect a target-matter, and when a location of the target-matter is inside of an irradiation region of the light.

11. The reliability correction device as set forth in claim 8, wherein the reliability modification device raises an upper limit-level of the degree of reliability, when the camera and the radar detect a same target-matter, and when a location of the target-matter is inside of an irradiation region of the light.

12. The reliability correction device as set forth in claim 8, wherein the reliability modification device does not change a value of the degree of reliability and/or does not change an upper limit-level of the degree of reliability, when the radar only detects a target-matter and the camera does not detect a target-matter, and when a location of the target-matter is outside of an irradiation region of the light.

13. The reliability correction device as set forth in claim 8, wherein the reliability modification device decreases a value of the degree of reliability and/or lowers an upper limit-level of the degree of reliability, when the camera only detects a target-matter and the radar does not detect a target-matter, and when a location of the target-matter is outside of an irradiation region of the light.

14. The reliability correction device as set forth in claim 8, wherein the reliability modification device does not change a value of the degree of reliability and/or does not change an upper limit-level of the degree of reliability, when the camera and the radar detect a same target-matter, and when a location of the target-matter is outside of an irradiation region of the light.

15. A method of modifying a degree of reliability, comprising:
a first process-step of acquiring a detection result of a target-matter, by a sensor, existing in surroundings of the sensor;
a second process-step of acquiring an irradiation range being an irradiation region of a light;
a third process-step of performing determination whether or not a target-matter being detected locates inside of an irradiation range of the light; and
a fourth process-step of modifying a degree of reliability with respect to target-matter information being detected, on a basis of a result of determination at the third process-step.

16. A motor vehicle operating system, comprising:
a reliability modification device for modifying a degree of reliability with respect to target-matter information being detected, with respect to a detection result of a target-matter, by a sensor, existing in surroundings of the sensor, on a basis of an irradiation range being an irradiation region of a light; and
a motor vehicle control device for controlling a motor vehicle, on a basis of a target-matter detection result including a degree of reliability being modified by the reliability modification device.
